(19) United States
(12) Patent Application Publication
(10) Pub. No.: US 2012/0187721 A1
(43) Pub. Date: Jul. 26, 2012

(54) CONSTRUCTION MACHINE

(75) Inventors: Manabu Nishimura, Hiroshima-shi (JP); Keiji Yamamoto, Hiroshima-shi (JP); Keiji Yamamoto, Hiroshima-shi (JP); Eiji Maeba, Hiroshima-shi (JP)

(73) Assignee: KOBELCO CONSTRUCTION MACHINERY CO., LTD, Hiroshima-shi (JP)

(21) Appl. No.: 13/355,982

(22) Filed: Jan. 23, 2012

(30) Foreign Application Priority Data
Jan. 25, 2011 (JP) 2011-012522

(51) Int. Cl. B62D 33/06

(52) U.S. Cl. 296/190.03

(57) ABSTRACT

A construction machine has a locking mechanism for locking a lower end of a front part of a guard member onto a bracket while allowing a cab to be moved with elastic deformation of an anti-vibration mount. The locking mechanism has a shaft body across the bracket and the guard member vertically movably with the guard member. The shaft body has a stopper to be engaged to an upper frame side to restrict a moving amount of the shaft body to a stroke for shock absorbing. The bracket has a bolt insertion hole for a bolt to fix the bracket and a shaft body insertion hole for the shaft body. The bolt insertion hole is a lateral oblong hole extending in a direction inclined, with respect to the horizontal direction, toward a direction orthogonal to a load acting direction in the lateral rollover.

### BACKGROUND OF THE INVENTION

1. Field of the Invention

The present invention relates to a construction machine, such as a hydraulic excavator, having a cab and a guard structure for protecting the cab when the construction machine laterally rolls over on its side of the cab to thereby secure an operator space within the cab.

2. Description of the Background Art

The background art of the invention will be explained by describing a hydraulic excavator shown in FIG. 9, as an example.

The hydraulic excavator comprises a crawler-type lower propelling body 1 and an upper slewing body 2 loaded on the lower propelling body 1 slewably about an axis O normal to the ground. The upper slewing body 2 has an upper frame 3, a cab 4 or a cabin disposed on one side of the upper frame 3 in right and left directions (a lateral direction) thereof to allow an operator to board it, a working attachment 6 attached to the upper frame 3 at a position opposite to the cab 4 so as to be capable of rising and falling, and a counterweight 7 provided at a rear end of the upper frame 3. The working attachment 6 has a boom 5. FIG. 9 shows a general hydraulic excavator in which the cab 4 is disposed on the left of the upper frame 3 and the working attachment 6 is disposed on the right of the upper frame 3, when viewed from the operator seated in the cab 4.

As shown in FIG. 10, the upper frame 3 has a left front part which constitutes a cab attachment portion 8. The cab 4 is mounted on the cab attachment portion 8 via a plurality of anti-vibration mounts 9, which are disposed at four corners on a bottom part of the cab 4 respectively. As disclosed in Japanese Unexamined Patent Publication No. 2004-189089 (patent document 1) and Japanese Patent No. 3,671,790 (patent document 2), each of the anti-vibration mounts 9 is formed of an elastic member such as an anti-vibration rubber member to elastically support the cab 4 movably in vertical and horizontal directions within a limited vertical stroke, thereby damping the vibrations of the cab 4.

As to such a type of hydraulic excavator, the cab standard (ROPS) requires the hydraulic excavator to be so designed that the deformation of the cab 4 be suppressed to secure a space for the operator called DLV (Deflection-Limiting Volume) within the cab 4 when the construction machine laterally rolls over on its side of the cab 4, that is, in the event of lateral rollover toward left side at which the cab 4 is disposed. Heretofore, there have been known various techniques using a guard member to meet the ROPS standard. For instance, Japanese Unexamined Patent Publication No. 2005-35316 (patent document 3) discloses mounting a guard member on an essential part of a cab e.g. on an upper half part of the cab, and Japanese Unexamined Patent Publication No. 2000-229548 (patent document 4) discloses mounting a guard member onto an upper frame so that the guard member surrounds a cab.

However, the guard member disclosed in patent document 3, which is mounted only on the cab, can provide less than an effect of reinforcing the cab itself, being ineffective against an external force in a direction of tearing the cab off from the upper frame when the construction machine laterally rolls over on its side of the cab, and thus may allow the cab to be removed from the upper frame. On the other hand, the guard member disclosed in patent document 4, which is mounted on the upper frame, is effective in preventing disengagement of the cab from the upper frame; however, if mounted on a machine provided with the anti-vibration mounts 9 as shown in FIG. 10, the guard member can impair the shock absorbing function of the anti-vibration mounts 9.

### SUMMARY OF THE INVENTION

An object of the invention is to provide a construction machine having an upper frame and a cab mounted on the upper frame via an anti-vibration mount and being capable of resisting an external force in a direction of tearing the cab off from the upper frame while keeping a shock absorbing function of the anti-vibration mount.

A construction machine provided by the invention includes a lower propelling body and an upper slewing body loaded on the lower propelling body slewably about an axis normal to the ground. The upper slewing body includes an upper frame; a cab disposed on one side of the upper frame in a lateral direction to allow an operator to board the cab; an anti-vibration mount for shock absorbing interposed between the cab and the upper frame and being elastically deformable so as to allow the cab to be displaced relatively to the upper frame in vertical and horizontal directions; a guard member attached to the cab so as to cover at least a front surface portion of the cab to protect the cab when the construction machine laterally rolls over on its side of the cab; a bracket disposed at a front end of the upper frame so as to project forwardly beyond the front end; and a locking mechanism for locking a lower end of a front part of the guard member which covers the front surface portion of the cab onto the bracket so as to allow the cab to be moved in the vertical and horizontal directions with accompanying elastic deformation of the anti-vibration mount. The locking mechanism has a shaft body extending across the bracket and the guard member and allowed to be moved integrally with the guard member in the vertical direction relatively to the upper frame. The shaft body has a stopper capable of being engaged to an upper frame side to restrict a movement of the shaft body to a magnitude corresponding to a stroke for shock absorbing by the anti-vibration mount.

In this construction machine, the guard member is operable to effectively resist against an external force acting in a direction of tearing the cab off from the upper frame while keeping a shock absorbing function of the anti-vibration mount.

Meanwhile, there is necessity of securing a clearance corresponding to a stroke for shock absorbing by elastic deformation of an anti-vibration mount, between the stopper and a top surface of the bracket, which requires the bracket to be disposed so as to enable the relative position of the bracket to the front end of the upper frame to be adjusted in a vertical direction. The adjustment may be achieved by e.g. combination of a through-hole formed in the bracket so as to have a large dimension in a vertical direction and a bolt to fix the bracket onto the upper frame while being inserted through the through-hole. However, such a vertically extending through-hole, whose longitudinal direction (vertical direction) is close to a load acting direction in which a load acts on the cab when the construction machine laterally rolls over on its side of the cab, that is, rolls over in such a direction that the cab falls on the ground (an upward direction inclined slightly rightward), allows a force equal to or in excess of a fastening force by the bolt to upwardly move the bracket together with the cab. This may allow the moving amount of the cab to be equal to or larger than a set value to thereby reduce the DLV in the cab.

In view of the above, to prevent the bracket from being upwardly moved in the event of rollover of the construction machine on its side of cab while allowing the position of the bracket to be vertically adjusted, the invention further includes the following configuration: the bracket is formed with a bolt insertion hole through which a bolt for fixing the bracket onto the front end of the upper frame is inserted and a shaft body insertion hole through which the shaft body of the locking mechanism is inserted, the bolt insertion hole being an oblong hole extending in a direction inclined, with respect to the horizontal direction, toward a direction orthogonal to a load acting direction in which a load acts on the cab when the construction machine laterally rolls over to lay on its side of the cab, that is, rolls over in such a direction that the cab falls on the ground; the shaft body insertion hole is an oblong hole extending in the lateral direction.

These and other objects, features and advantages of the present invention will become more apparent upon reading the following detailed description along with the accompanying drawings.

### BRIEF DESCRIPTION OF THE DRAWINGS

FIG. 1 is an exploded perspective view showing an upper frame and a cab of a hydraulic excavator, as an example of a construction machine embodying the invention.

FIG. 2 is a perspective view showing a state that the upper frame and the cab are assembled.

FIG. 3 is a side view showing a state that the upper frame and the cab are assembled.

FIG. 4 is a front view showing a state that the upper frame and the cab are assembled.

FIG. 5 is an enlarged view of a part V shown in FIG. 4.

FIG. 6 is a cross-sectional view taken along the line VI-VI in FIG. 5.

FIG. 7 is a cross-sectional view taken along the line VII-VII in FIG. 6.

FIG. 8 is a perspective view partly cutaway to show a bracket of a bracket attachment structure in the construction machine.

FIG. 9 is a schematic perspective view of a hydraulic excavator, as an example to which the present invention is applied.

FIG. 10 is an exploded perspective view showing an upper frame and a cab of the hydraulic excavator shown in FIG. 9.

### DESCRIPTION OF THE PREFERRED EMBODIMENTS

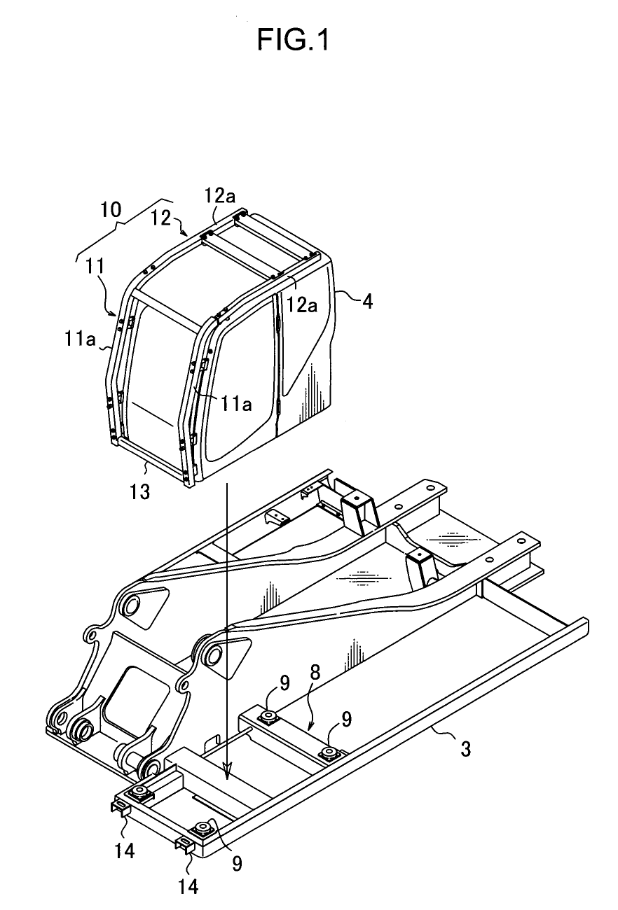

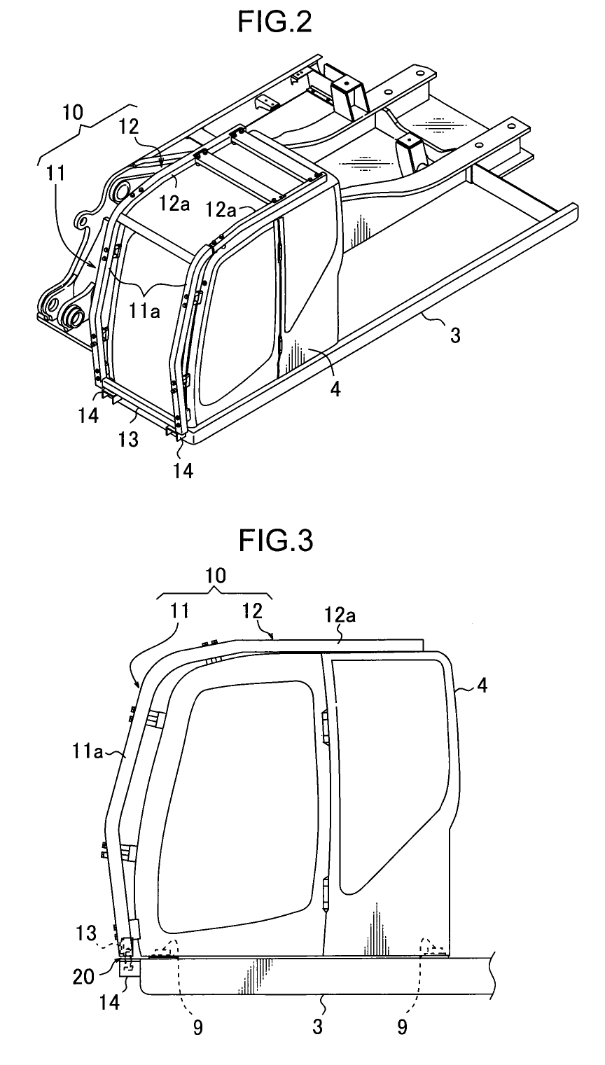

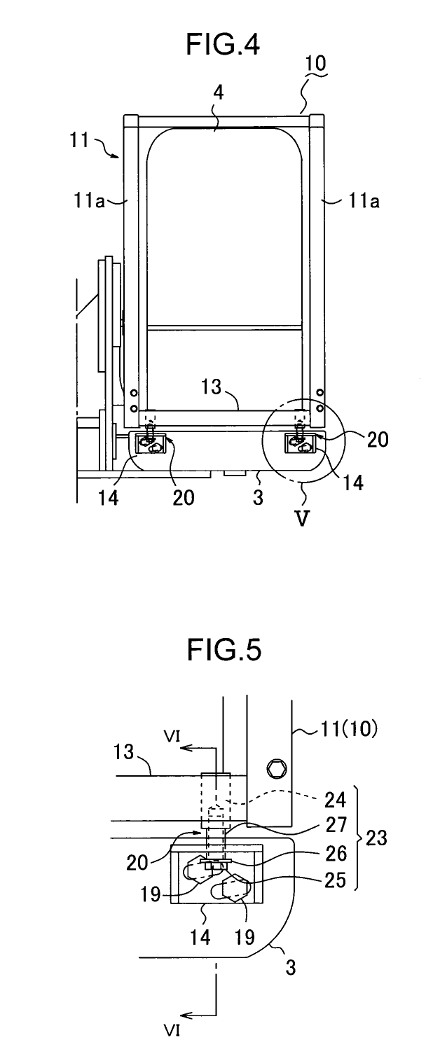

An embodiment of the invention is described, mainly referring to FIGS. 1 to 8.

The basic configuration of a hydraulic excavator embodying the invention is substantially the same as that shown in FIG. 9. Specifically, as shown in FIG. 9, the hydraulic excavator comprises a crawler-type lower propelling body 1, and an upper slewing body 2 loaded on the lower propelling body 1 slewably about an axis O normal to the ground. The upper slewing body 2 has an upper frame 3; a cab 4 disposed on a part corresponding to one side (on the left side in FIG. 9) of the upper frame 3 in right and left directions (a lateral direction) to allow an operator to board the cab 4, a working attachment 6 attached to the upper frame 3 at a position on a side (on the right side in FIG. 9) opposite to the cab 4 so as to be able to rise and fall, and a counterweight 7 provided at a rear end of the upper frame 3. The working attachment 6 has a boom 5.

As shown in FIG. 1, the upper frame 3 has a left front part which constitutes a cab attachment portion 8. The cab 4 is mounted on the cab attachment portion 8 so as to be elastically supported via a plurality of anti-vibration mounts 9. The anti-vibration mounts 9 are disposed at four corners of the cab attachment portion 8, respectively.

The hydraulic excavator further comprises a guard member 10, right and left brackets 14 and 14, and locking mechanisms 20, as shown in FIG. 3 to FIG. 6, provided for the brackets 14 respectively.

The guard member 10 is attached to the cab 4 to protect the cab 4 in the event of lateral rollover of the hydraulic excavator on its side of the cab 4 (when the hydraulic excavator rolls over in such a direction that the cab 4 falls toward the ground). The guard member 10 has a shape of including a front part 11 covering lateral ends of a front surface portion of the cab 4 and a rear part 12 extending rearward from an upper end of the front part 11 to cover a ceiling of the cab 4, the parts 11 and 12 being continued to each other, that is, has a hook shape when viewed from a side direction. The front part 11 and the rear part 12 are attached to appropriate positions of the cab 4, specifically, attached to a framework including a front pillar of the cab 4, by bolts.

The front part 11 is in a frame shape having right and left frames 11a and 11a, and a plurality of beam members disposed between the right and left frames 11a and 11a. Likewise, the rear part 12 is in a frame shape having right and left frames 12a and 12a, and a plurality of beam members disposed between the right and left frames 12a and 12a. The beam members of the front part 11 include a beam member 13 disposed at a lower end of the front part 11. The beam member 13 is suspended between respective lower ends of the right and left frames 11a and 11a and fixed to the ends.

The brackets 14 and 14 are attached to respective lateral end portions on a front end of the upper frame 3 so as to project forwardly beyond the front end, and above the brackets 14 and 14 the beam member 13 of the front part 11 of the guard member 10 is disposed. The locking mechanisms 20 are provided for the brackets 14 respectively. Each of the locking mechanisms 20 is adapted to lock the beam member 13 constituting the lower end of the front part 11 of the guard member 10 onto the corresponding bracket 14, having a shaft body 23 disposed to extend across the bracket 14 and the guard member 10 as will be described later in detail.

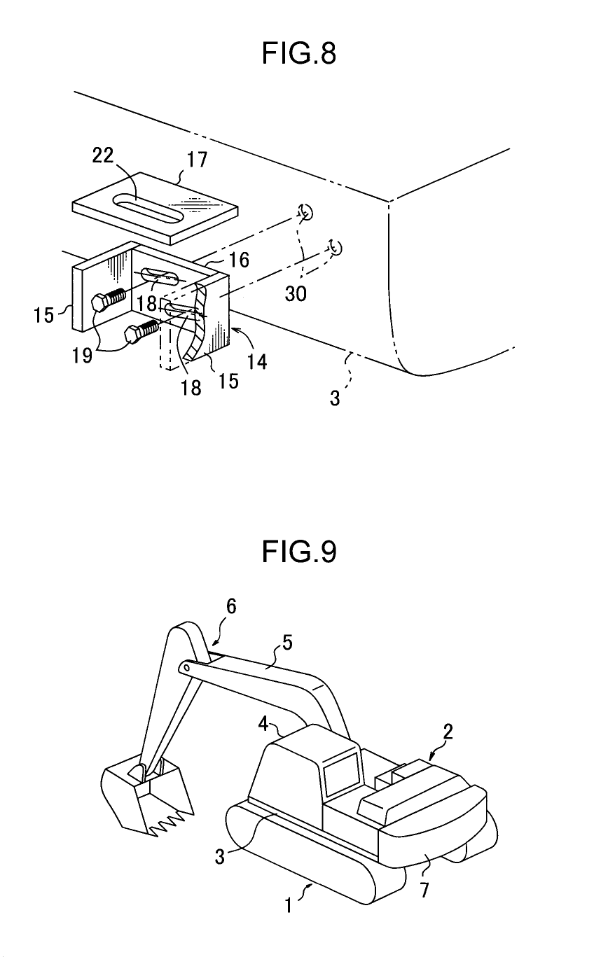

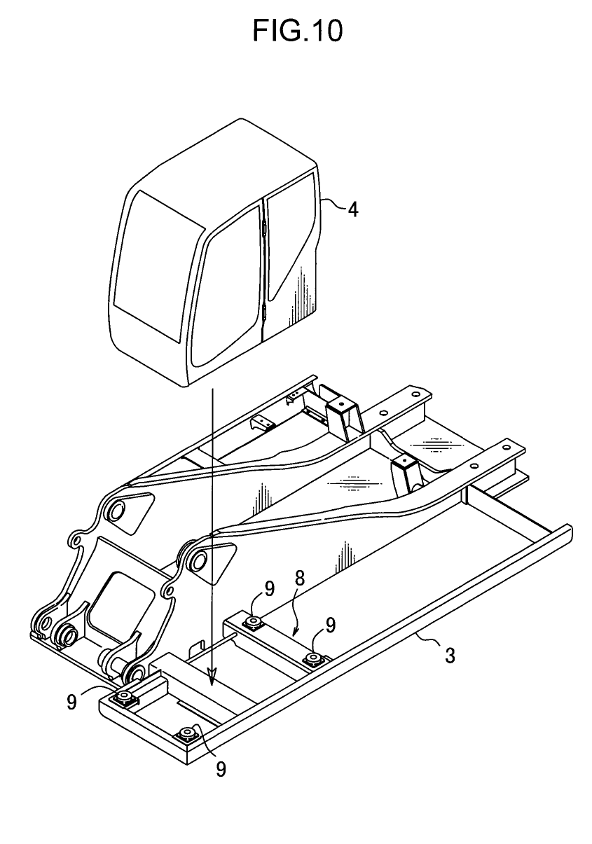

The right and left brackets 14 and 14 have the same shape as each other. As shown in FIG. 8, each of the brackets 14 has vertical right and left plates 15 and 15 disposed in parallel to each other with a certain clearance in a lateral direction, a back plate 16 bridged between the lower ends of the right and left plates 15 and 15, and a horizontal top plate 17 covering the space surrounded by the right and left plates 15 and 15 and the back plate 16 from above. The top plate 17 is formed with a shaft body insertion hole 22 through which the shaft body 23 can be vertically inserted.

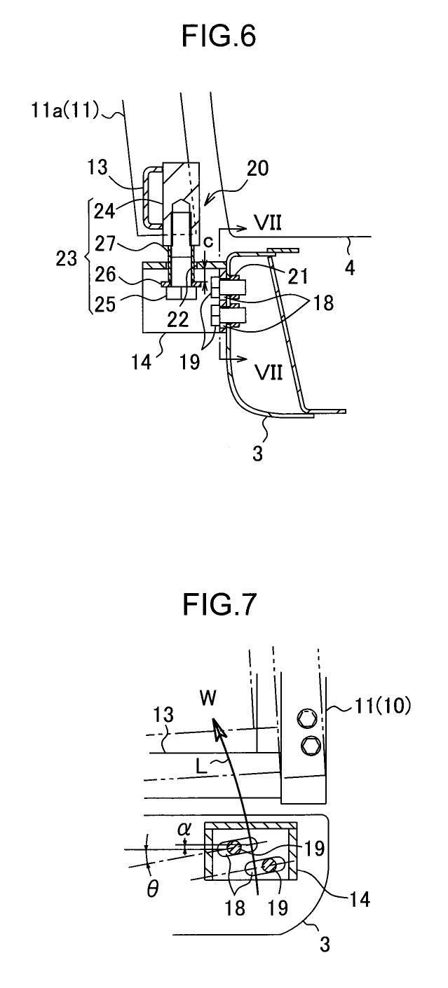

Each of the brackets 14 is attached to the front end of the upper frame 3 by use of a plurality of attachment bolts 19 (two attachment bolts in FIG. 6 and FIG. 8) and nuts 21 shown in FIG. 6. Specifically, as shown in FIG. 8, the back plate 16 is formed with a plurality of bolt insertion holes 18 (two bolt insertion holes in FIG. 8) through which the respective attachment bolts 19 are insertable. Each of the attachment bolts 19 is inserted through the corresponding bolt insertion hole 18 and further a bolt insertion hole 30 formed in the front end of the upper frame 3. The nuts 21 are attached and fastened onto the attachment bolts 19 respectively, thereby fixing the bracket 14 onto the front end of the upper frame 3 in a state that the back plate 16 of the bracket 14 extends along the front end of the upper frame 3 and making the top plate 17 project forwardly from an upper end of the back plate 16.

The shape of each of the bolt insertion holes 18 and 18 is defined to establish both of: enabling the attachment position of the bracket 14 to be vertically adjusted in relation to a locking mechanism 20 which will be described later; and resisting a load acting on the cab 4 when the hydraulic excavator laterally rolls over on its side of the cab 4. The detail is as follows.

The bolt insertion hole 18 and 18 might be vertically extending oblong holes, if required were only enabling the attachment position of the bracket 14 to be vertically adjusted. However, if the bolt insertion hole 18 and 18 are vertically extending oblong holes, the bracket 14 cannot resist a load acting on the cab 4 when the hydraulic excavator laterally rolls over on its side of the cab 4. If the hydraulic excavator laterally rolls over on such a side that the cab 4 falls toward the ground, the cab 4 will receive a load W in the direction as shown in FIG. 7, specifically, the direction indicated by a load acting line L, when an upper end portion of the cab 4 touches the ground. The direction of the load W is an obliquely upward direction i.e. a slightly and obliquely rightward direction when viewed from the cab 4 (a slightly and obliquely leftward direction in the front view of FIG. 7). If each of the bolt insertion holes 18 and 18 were simply vertically extending oblong hole, the longitudinal direction of the attachment hole 18 substantially would coincide with the direction of the load W shown in FIG. 7 (i.e. the direction of the load acting line L), which allows a load equal to or larger than the fastening force of the attachment bolts 20 and the nuts 21 to move the bracket 14 together with the cab 4 upward. If the movement amount of the cab 4 thus produced reaches or exceeds a set value based on the locking mechanism 20 to be described later, the DLV in the cab 4 may be decreased.

In view of the above, each of the bolt insertion holes 18 and 18 in this embodiment is, as shown in FIG. 7, formed into a laterally oblong hole extending in a direction inclined by the angle θ, with respect to the horizontal direction, toward a direction orthogonal to the load acting line L, in other words, in a direction slightly and obliquely leftward and upward when viewed from a rear side (in a direction slightly and obliquely rightward and downward in FIG. 7). This effectively restrains the bracket 14 from being moved together with the cab 4 in the direction of the load acting line L when the hydraulic excavator laterally rolls over on its side of the cab 4. Furthermore, the bolt insertion hole 18 and 18, having respective longitudinal directions which is inclined with respect to the horizontal direction to include an up-and-down direction component α as shown in FIG. 7, allows the attachment position of the bracket 14 to be vertically adjusted.

The most preferable longitudinal direction of the bolt insertion hole 18 and 18 is one orthogonal to the load acting line L; however, the invention is not necessarily limited to this direction. The longitudinal direction only has to be inclined toward the “direction orthogonal to the horizontal direction” in order to allow the position of the bracket 14 to be vertically adjusted while restraining the bracket 14 from its upward movement when the hydraulic excavator laterally rolls over on its side of the cab 4. In other words, the inclination angle θ of the longitudinal direction of the bolt insertion hole 18 and 18 with respect to the horizontal direction is permitted to be set to any value, as necessary, depending on a required magnitude of the up-and-down component α as long as the upward movement of the bracket 14 can be prevented when the hydraulic excavator laterally rolls over on its side of the cab 4.

In the arrangement such that the position of the bracket 14 is adjusted in up and down directions by the up-and-down direction component a (i.e. an inclination component) of the bolt insertion hole 18, 18 extending in a direction close to the horizontal direction as described above, only a slight vertical change in the position of the bracket 14 may greatly vary the position of the bracket 14 laterally, that is, horizontally of the bracket 14. This may greatly displace the bracket 14 relatively to the locking mechanism 20 to be described later. In view of the above, the shaft body insertion hole 22 formed in the top plate 17 of the bracket 14 is formed into an oblong hole extending in a lateral direction so that the relative position between the shaft body 23 and the bracket 14 in the lateral direction can be adjusted.

Next will be described the locking mechanism 20 provided for each of right and left sides of the hydraulic excavator in detail referring to FIG. 5 and FIG. 6.

The shaft body 23 of each of the locking mechanisms 20, which is disposed to extending across the bracket 14 and the beam member 13 while vertically extending through the shaft body insertion hole 22 of the bracket 14, has a female thread body 24, a bolt 25 corresponding to a screw shaft, a stopper 26, and a sleeve 27. The female thread body 24 has a screw hole and is fixed to the beam member 13 in such an attitude that the screw hole vertically extends and is opened downward. The bolt 25 has a screw shaft portion and a head portion of a larger diameter than that of the screw shaft portion. The screw shaft portion, which corresponds to an insertion portion in the present invention, is inserted through the shaft body insertion hole 22 from the side of the bracket 14 i.e. from below to be screwed into the female thread body 24. The stopper 26 has a ring shape with an outer diameter larger than both of the outer diameter of the screw shaft portion and the width of the shaft body insertion hole 22. In other words, the stopper 26 has a dimension which allows the stopper 26 to be engaged to the top plate 17 of the bracket 14 in accordance with the upward displacement of the stopper 26 relatively to the bracket 14. The stopper 26 is fitted and fixed onto the screw shaft portion so as to radially outwardly project beyond the screw shaft portion of the bolt 25 at a position below the top plate 17 of the bracket 14. The sleeve 27 is interposed between the lower end of the female screw portion 24 and the stopper 26, pressing the stopper 26 against the head portion of the bolt 25 from above to fix the stopper 26.

In this locking mechanism 20, the bolt 25 is screwed into the female thread body 24 so as to define a clearance “c” of a magnitude corresponding to the stroke for shock absorbing by elastic deformation of the anti-vibration mounts 9, between the stopper 26 and a lower surface of the top plate 17 of the bracket 14, thereby restricting the vertical movement of the shaft body 23 relatively to the bracket 14 of the shaft body 23 to the dimension of the clearance “c”. In other words, the stopper 26 is engaged to the top plate 17 of the bracket 14 upon the upward displacement of the cab 4 and the shaft body 23 relatively to the upper frame 3 and the bracket 14 by the stroke corresponding to the clearance “c”, thus preventing the cab 4 and the shaft body 23 from an upward displacement over the dimension corresponding to the clearance “c” is restricted.

The front part 11 of the guard member 10 is thus connected to the front end of the upper frame 3 via each of the right and left locking mechanisms 20 and the brackets 14 while being allowed to vertically move within a range of the clearance “c” corresponding to the stroke for shock absorbing by the anti-vibration mounts 9.

The locking mechanism 20 according to this embodiment is able to receive an external force acting in a direction of tearing the cab 4 off from the upper frame 3 when the hydraulic excavator laterally rolls over to thereby prevent the cab 4 from being removed from the upper frame 3, while keeping the shock absorbing function of the anti-vibration mounts 9. Furthermore, the locking mechanism 20, disposed between the guard member 10 capable of being given a large strength with ease and the upper frame 3, can ensure the effect of preventing the cab 4 from being removed. Moreover, attaching the guard member 10 to the cab 4 so as to bridge between the front surface portion and the ceiling of the cab 4 enables the cab 4 and the guard member 10 to be mutually reinforced to thereby exhibit a high resistive force against an external force acting in a direction of tearing the cab 4 off from the upper frame 3 in cooperation with each other.

Besides, the brackets 14, 14 projecting forwardly beyond the front end of the upper frame 3 and the locking mechanisms 20 and 20 locking the lower end of the front part 11 of the guard member 10 onto the brackets 14 and 14 eliminate the need of large-scale modification such as forwardly extending the upper frame 3. This allows the above configuration to be easily added to an existing machine.

In addition, the locking mechanism 20 is allowed to be easily incorporated into the structure machine with a simplified structure by the following arrangement: the shaft body 23 of the locking mechanism 20 extends across a member on the upper frame side (the bracket 14 in this embodiment) and a member on the guard member side (the beam member 13 in this embodiment) while being vertically movable together with the guard member 10; and the stopper 26 is engaged to the beam member 13, which is a member on the side of the upper frame 3, to thereby restrict the movement amount of the shaft body 23 to a magnitude corresponding to the shock absorbing stroke of the anti-vibration mounts 9.

Furthermore, since the female thread body 24 of the shaft body 23 is fixed to the side of the guard member 10 and the bolt 25 to which the stopper 26 is attached is screwed into the female thread body 24 from the side of the bracket 14, the locking mechanism 20 can be simplified, in addition to the advantage of the vertically adjustable position of the bracket 14 as described above. Besides, fastening the bolt 25 brings the sleeve 27 into pressure contact with the female thread body 24 to thereby generate an axial force of downwardly pressing the bolt 25, the axial force preventing the bolt 25 from being loosed and keeping the clearance “c”, that is, an amount of the permitted movement of the shaft body 23, be constant. This clearance “c” can be arbitrarily and easily selected and adjusted by changing the length of the sleeve 27.

The invention is not limited to the foregoing embodiment but includes, for example, the following modifications.

(1) There may be used one or more than two attachment bolts 19 for the attachment of the bracket 14 to the lower end of the upper frame 3. The number of the bolt insertion holes 18 to be formed should be determined based on the number of the attachment bolts 19. Also the number of the brackets 14 or the locking mechanisms 20 is not limited. For instance, the bracket 14 and the locking mechanism 20 may be disposed at three positions i.e. right and left positions and an intermediate position between the right and left positions, or at more than three positions.

(2) Although, in the embodiment, the front end surface of the upper frame 3 is a vertical surface and the back plate 16 of the bracket 14 is a vertical plate extending along the front end surface of the upper frame 3, the bolt insertion hole 18 horizontally extending through the back plate 16 in front and rear directions (a longitudinal direction), in the case where the front end surface of the upper frame 3 is a forwardly downward slope or a forwardly upward slope, the back plate 16 of the bracket 14 may be formed into a slope plate extending along the front end surface of the upper frame 3, and the bolt insertion hole 18 may be formed into a through-hole inclined in the longitudinal direction at a right angle with respect to the back plate 16. In this case, the vertical adjustment of the position of the bracket 14 utilizing the shape of the bolt insertion hole 18 involves a longitudinal change in the position; the shaft body insertion hole 22 is therefore preferably formed into an oblong hole having a large dimension in the longitudinal direction to absorb displacement in the longitudinal direction.

(3) The guard member 10 may be constituted only of the front part 11 of the embodiment. In other words, the rear part 12 of the guard member 10 may be omitted.

(4) While the shaft body 23 in the embodiment of the locking mechanism 20 has the screw shaft (bolt) 18, the female thread body 24, the stopper 26, and the sleeve 27, the shaft body may be formed of a shaft having a head portion at a lower end thereof, as a stopper. Although this case, the shaft may extend through the shaft body insertion hole 22 of the bracket 14, and may be disposed to extend across the bracket 14 and the beam member 13, while defining a clearance between the head portion and the top surface of the bracket 14 in the same manner as in the embodiment; and an upper end of the shaft may be fixed to the beam member 13.

(5) The invention is not limited to a hydraulic excavator, but may be broadly applied to a construction machine having a cab mounted on an upper frame via an anti-vibration mount, including a demolishing machine and a crushing machine constructed on the basis of a hydraulic excavator.

As described above, the invention provides a construction machine which has an upper frame and a cab mounted on the upper frame via an anti-vibration mount and allows the cab to resist against an external force of tearing the cab off from the upper frame, without impairing a shock absorbing function of the anti-vibration mount. The construction machine comprises a lower propelling body and an upper slewing body loaded on the lower propelling body slewably about an axis normal to the ground. The upper slewing body includes an upper frame; a cab disposed on one side of the upper frame in a lateral direction to allow an operator to board the cab; an anti-vibration mount for shock absorbing interposed between the cab and the upper frame and being elastically deformable so as to allow the cab to be displaced relatively to the upper frame in vertical and horizontal directions; a guard member attached to the cab so as to cover at least a front surface portion of the cab to protect the cab when the construction machine laterally rolls over on its side of the cab; a bracket disposed at a front end of the upper frame so as to project forwardly beyond the front end; and a locking mechanism for locking a lower end of a front part of the guard member which covers the front surface portion of the cab onto the bracket so as to allow the cab to be moved in the vertical and horizontal directions with accompanying elastic deformation of the anti-vibration mount. The locking mechanism has a shaft body which is disposed to extend across the bracket and the guard member and allowed to be vertically moved together with the guard member relatively to the upper frame. The shaft body has a stopper capable of being engaged to an upper frame side to restrict a movement of the shaft body to a magnitude corresponding to a stroke for shock absorbing by the anti-vibration mount.

In this construction machine, the guard member is operable to effectively resist against an external force acting in a direction of tearing the cab off from the upper frame while keeping a shock absorbing function of the anti-vibration mount.

Furthermore, in the construction machine provided by the invention, the bracket is formed with a bolt insertion hole through which a bolt for fixing the bracket onto the front end of the upper frame is inserted and a shaft body insertion hole through which the shaft body of the locking mechanism is inserted. The bolt insertion hole is an oblong hole extending in a direction inclined, with respect to the horizontal direction, toward a direction orthogonal to a load acting direction in which a load acts on the cab when the construction machine laterally rolls over to lay on its side of the cab, that is, rolls over in such a direction that the cab falls on the ground, while the shaft body insertion hole is an oblong hole extending in the lateral direction.

The longitudinal direction of the bolt insertion hole, which is a direction inclined toward a direction orthogonal to the direction of a load acting on the cab when the construction machine laterally rolls over on its side of the cab, with respect to the horizontal direction, enables the bracket to be prevented from being pulled by the cab to be upwardly moved when the construction machine laterally rolls over on its side of the cab, while allowing the position of the bracket to be vertically adjusted by utilization of a vertical direction component contained in the longitudinal direction. This makes it possible to restrict the amount of the movement of the cab within a range of the shock absorbing stroke by elastic deformation of the anti-vibration mount to secure a sufficient DLV.

Furthermore, even if the vertical adjustment of the bracket by utilization of the bolt insertion hole involves the displacement of the bracket relative to the shaft body in the lateral direction, the shaft body insertion hole formed in the bracket, which is a laterally extending oblong hole, allows the position of the bracket relative to the shaft body to be suitably adjusted in the lateral direction.

For instance, the shaft body preferably includes a female thread body fixed to a guard member side, a screw shaft screwed into the female thread body from a side of the upper frame, and a sleeve fitted onto the screw shaft, the sleeve being adapted to make pressure contact with the female thread body by a fastening force applied to the screw shaft to thereby generate an axial force to prevent the screw shaft from being loosened. The engagement between the female thread body and the screw shaft makes it easy to incorporate the locking mechanism. Moreover, the fastening force applied to the screw shaft brings the sleeve into pressure contact with the female thread body to thereby generate an axial force for preventing the screw shaft from being loosened by e.g. vibrations, thus keeping the clearance between the stopper and the bracket be constant.

On the other hand, the guard member may preferably include, in addition to the front part, a rear part extending rearwardly from an upper end of the front part to cover a ceiling of the cab, both the front part and the rear part being attached to the cab. Thus attaching the guard member to the cab so as to bridge between the front surface portion of the cab and the cab ceiling enables the cab and the guard member to reinforce each other to perform a high resistance against an external force acting in a direction of tearing the cab off from the upper frame by cooperation of the cab and the guard member. In short, the above arrangement enables the bracket and the locking mechanism to more surely prevent the cab from removal from the upper frame.

It is preferable that: the bracket has a back plate extending along a front end surface of the upper frame and a top plate projecting forwardly from an upper end of the back plate; the bolt insertion hole is formed in the back plate; and the shaft body insertion hole is formed in the top plate. The thus configured bracket can be easily fixed to the upper frame so that its back plate extends along the front end surface of the upper frame, and, the top plate can project forwardly beyond the upper frame. This arrangement allows the front part of the guard member above the bracket to be engaged to the bracket via the shaft body inserted through the shaft body insertion hole of the top plate.

In this case, the shaft body may preferably have an insertion portion to be inserted in the shaft body insertion hole, the stopper being disposed at a lower position than that of the top plate of the bracket and having a dimension large enough to enable the stopper to be engaged to the top plate of the bracket in accordance with the upward displacement of the stopper relative to the bracket. The shaft body enables the allowable stroke of relative vertical movement of the guard member with respect to the upper frame to be easily determined by setting the clearance between the top plate and the stopper.

This application is based on Japanese Patent Application No. 2011-012522 filed on Jan. 25, 2011, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A construction machine, comprising:
a lower propelling body; and
an upper slewing body loaded on the lower propelling body slewably about an axis normal to the ground,
the upper slewing body including:
an upper frame;
a cab disposed on one side of the upper frame in a lateral direction to allow an operator to board the cab;
an anti-vibration mount for shock absorbing, the anti-vibration mount interposed between the cab and the upper frame, and being elastically deformable so as to allow the cab to be displaced relatively to the upper frame in vertical and horizontal directions;
a guard member attached to the cab so as to cover at least a front surface portion of the cab to protect the cab when the construction machine laterally rolls over on its side of the cab;
a bracket disposed at a front end of the upper frame so as to project forwardly beyond the front end; and
a locking mechanism for locking a lower end of a front part of the guard member which covers the front surface portion of the cab onto the bracket so as to allow the cab to be moved in the vertical and horizontal directions with accompanying elastic deformation of the anti-vibration mount, wherein
the locking mechanism has a shaft body which is disposed to extend across the bracket and the guard member and allowed to be moved integrally with the guard member in the vertical direction relatively to the upper frame, the shaft body having a stopper capable of being engaged to an upper frame side to restrict a movement of the shaft body to a magnitude corresponding to a stroke for shock absorbing by the anti-vibration mount, and
the bracket is formed with a bolt insertion hole through which a bolt for fixing the bracket onto the front end of the upper frame is inserted and a shaft body insertion hole through which the shaft body of the locking mechanism is inserted, the bolt insertion hole being an oblong hole extending in a direction inclined, with respect to the horizontal direction, toward a direction orthogonal to a load acting direction in which a load acts on the cab when the construction machine laterally rolls over to lay on its side of the cab, the shaft body insertion hole being an oblong hole extending in the lateral direction.

2. The construction machine according to claim 1, wherein
the shaft body includes a female thread body fixed to a guard member side, a screw shaft screwed into the female thread body from a side of the upper frame, and a sleeve fitted onto the screw shaft, the sleeve being adapted to make pressure contact with the female thread body by a fastening force applied to the screw shaft to thereby generate an axial force to prevent the screw shaft from being loosened.

3. The construction machine according to claim 1, wherein
the guard member includes, in addition to the front part, a rear part extending rearwardly from an upper end of the front part to cover a ceiling of the cab, both the front part and the rear part being attached to the cab.

4. The construction machine according to claim 1, wherein:
the bracket has a back plate extending along a front end surface of the upper frame and a top plate projecting forwardly from an upper end of the back plate;
the bolt insertion hole is formed in the back plate; and
the shaft body insertion hole is formed in the top plate.

5. The construction machine according to claim 4, wherein:
the shaft body has an insertion portion to be inserted in the shaft body insertion hole; and
the stopper is disposed at a position lower than that of the top plate of the bracket and has a dimension large enough to enable the stopper to be engaged to the top plate of the bracket in accordance with the upward displacement of the stopper relative to the bracket.
